(19) United States
(12) Patent Application Publication
(10) Pub. No.: US 2026/0197589 A1
(43) Pub. Date: Jul. 9, 2026

(54) THIN MULTI-MAGNETIC VIBRATION-DAMPING LOUDSPEAKER

(71) Applicant: FORTUNE GRAND TECHNOLOGY INC., Taoyuan City (TW)

(72) Inventors: PING-YU LEE, Taoyuan City (TW); PEI-JUNG LEE, Taoyuan City (TW); DE-WU WANG, Taoyuan City (TW); DE-XIANG YANG, Taoyuan City (TW)

(73) Assignee: FORTUNE GRAND TECHNOLOGY INC., Taoyuan City (TW)

(21) Appl. No.: 19/079,448

(22) Filed: Mar. 13, 2025

(30) Foreign Application Priority Data
Jan. 9, 2025 (CN) 202510040254.4

(51) Int. Cl. H04R 9/02; H04R 7/04; H04R 9/04; H04R 9/06

(52) U.S. Cl. CPC H04R 9/025; H04R 7/04; H04R 9/045; H04R 9/06; H04R 2400/11

(57) ABSTRACT

A thin multi-magnetic vibration-damping loudspeaker includes a speaker base, a magnetic assembly, first elastic members and a vibration assembly. Thereby, the thin multi-magnetic vibration-damping loudspeaker of the present disclosure can provide more magnetic energy to increase a volume during operation and can reduce vibration of the speaker base to reduce resonance and improve stability during operation.

### CROSS-REFERENCE TO RELATED APPLICATION

This non-provisional application claims priority under 35 U.S.C. § 119(a) on Patent Application No(s). 202510040254.4 filed in Taiwan, R.O.C. on Jan. 9, 2025, the entire contents of which are hereby incorporated by reference.

### BACKGROUND OF THE INVENTION

### 1. Field of the Invention

The present disclosure provides a thin multi-magnetic vibration-damping loudspeaker, and in particular to a thin multi-magnetic vibration-damping loudspeaker, which can provide more magnetic energy to increase a volume during operation and can reduce vibration of a speaker base to reduce resonance and improve stability during operation.

### 2. Description of the Related Art

A magnetic assembly of a typical loudspeaker at present is usually a mono-magnetic structure. Due to the limited magnetic energy provided by the mono-magnetic structure, it is impossible to increase the volume of the loudspeaker during operation. Moreover, if the loudspeaker uses a long thin speaker base, it is more likely that the loudspeaker will not be able to output sound stably.

Therefore, how to create a thin multi-magnetic vibration-damping loudspeaker which can provide more magnetic energy to increase a volume during operation and can reduce vibration of the speaker base to reduce resonance and improve stability during operation will be a point which the present disclosure intends to positively disclose.

### BRIEF SUMMARY OF THE INVENTION

In view of the defects in the prior art, the inventor intends to develop a thin multi-magnetic vibration-damping loudspeaker, which can provide more magnetic energy by using a magnetic assembly to increase a volume during operation and can reduce vibration of a speaker base by using first elastic members to reduce resonance and improve stability during operation.

In order to achieve the above objective and other objectives, the present disclosure provides a thin multi-magnetic vibration-damping loudspeaker, including: a speaker base, a magnetic assembly, two first elastic members and a vibration assembly. The magnetic assembly includes a magnetic plate, a main magnetic unit, at least one first auxiliary magnetic unit and at least one second auxiliary magnetic unit. The main magnetic unit is arranged at the magnetic plate. The first auxiliary magnetic unit is arranged at the magnetic plate and on one side of the main magnetic unit at an interval. The second auxiliary magnetic unit is arranged at the magnetic plate and on the other side of the main magnetic unit at an interval. A first spacing exists between a top of the first auxiliary magnetic unit and the speaker base. A second spacing exists between a top of the second auxiliary magnetic unit and the speaker base. Each of the first elastic members are connected between the speaker base and the magnetic assembly. The vibration assembly includes a vibrating diaphragm and a voice coil. The vibrating diaphragm is arranged at the speaker base, and the voice coil is movably arranged at the magnetic assembly and connected to the vibrating diaphragm.

In the above thin multi-magnetic vibration-damping loudspeaker, a side of the top of the first auxiliary magnetic unit is provided with a first concave portion corresponding to the speaker base. The first spacing exists between the first concave portion and the speaker base. A side of the top of the second auxiliary magnetic unit is provided with a second concave portion corresponding to the speaker base. The second spacing exists between the second concave portion and the speaker base.

In the above thin multi-magnetic vibration-damping loudspeaker, the speaker base includes a speaker base holder and a metal holder. The speaker base holder partially covers the metal holder. The side of the top of the first auxiliary magnetic unit is provided with the first concave portion corresponding to the metal holder. The first spacing exists between the first concave portion and the metal holder. The side of the top of the second auxiliary magnetic unit is provided with the second concave portion corresponding to the metal holder. The second spacing exists between the second concave portion and the metal holder.

In the above thin multi-magnetic vibration-damping loudspeaker, the metal holder is made of austenitic stainless steel.

In the above thin multi-magnetic vibration-damping loudspeaker, the metal holder has two short side portions or two long side portions. Sections of the short side portions are respectively L-shaped, and sections of the long side portions are respectively L-shaped.

In the above thin multi-magnetic vibration-damping loudspeaker, the metal holder has two short side portions and two long side portions. Two ends of each of the long side portions are respectively provided with a first welding portion to be adjacent to the short side portions. The speaker base holder is injection-molded to partially cover the metal holder. Each of the first welding portions is exposed from the speaker base holder. The first elastic members are respectively welded to the first welding portions.

In the above thin multi-magnetic vibration-damping loudspeaker, two sides of the magnetic plate are respectively provided with a first connecting groove, and one side of each of the first elastic members is arranged at each of the first connecting grooves.

In the above thin multi-magnetic vibration-damping loudspeaker, two sides of the main magnetic unit respectively correspond to the first connecting grooves, and one side of each of the first elastic members is sandwiched between each of the first connecting grooves and the main magnetic unit.

In the above thin multi-magnetic vibration-damping loudspeaker, the main magnetic unit is provided with a main magnet and a main magnetic plate stacked with each other. The main magnet is closely attached to the magnetic plate. A number of the first auxiliary magnetic unit is one. The first auxiliary magnetic unit is provided with a first auxiliary magnet and a first auxiliary magnetic plate stacked with each other. The first auxiliary magnet is closely attached to the magnetic plate. The first concave portion is provided on a side of a top of the first auxiliary magnetic plate. A number of the second auxiliary magnetic unit is one. The second auxiliary magnetic unit is provided with a second auxiliary magnet and a second auxiliary magnetic plate stacked with each other. The second auxiliary magnet is closely attached to the magnetic plate. The second concave portion is provided on a side of a top of the second auxiliary magnetic plate, so as to form a tri-magnetic magnetic assembly.

In the above thin multi-magnetic vibration-damping loudspeaker, the main magnetic unit is provided with a main magnet and a main magnetic plate stacked with each other. The main magnet is closely attached to the magnetic plate. A number of the first auxiliary magnetic unit is two and the two first auxiliary magnetic units are arranged at an interval. Each of the first auxiliary magnetic units is provided with a first auxiliary magnet and a first auxiliary magnetic plate stacked with each other. Each of the first auxiliary magnets is closely attached to the magnetic plate. The first concave portion is arranged on a side of a top of each of the first auxiliary magnetic plates. A number of the second auxiliary magnetic unit is two and the two second auxiliary magnetic units are arranged at an interval. Each of the second auxiliary magnetic units is provided with a second auxiliary magnet and a second auxiliary magnetic plate stacked with each other. Each of the second auxiliary magnets is closely attached to the magnetic plate. The second concave portion is arranged on a side of a top of each of the second auxiliary magnetic plates, so as to form a penta-magnetic magnetic assembly.

In the above thin multi-magnetic vibration-damping loudspeaker, the first spacing is greater than 0.2 mm, and the second spacing is greater than 0.2 mm.

In the above thin multi-magnetic vibration-damping loudspeaker, each of the first elastic members includes two first outer fixing portions, a first inner fixing portion and two first elastic portions. The first elastic portions are arranged between the first outer fixing portions and the first inner fixing portion. The first outer fixing portions are connected to the metal holder. The first inner fixing portion is arranged at the magnetic plate.

In the above thin multi-magnetic vibration-damping loudspeaker, the first inner fixing portion is sandwiched between the magnetic plate and the main magnetic unit.

In the above thin multi-magnetic vibration-damping loudspeaker, each of the first outer fixing portions is provided with at least one first through hole, and each of the first outer fixing portions is welded to the metal holder through the first through hole.

In the above thin multi-magnetic vibration-damping loudspeaker, the metal holder has two short side portions and two long side portions. Two ends of each of the long side portions are respectively provided with a first welding portion to be adjacent to the short side portions. A second welding portion is arranged respectively two ends of each of the long side portions. The speaker base holder is injection-molded to partially cover the metal holder. Each of the first welding portions and each of the second welding portions are exposed from the speaker base holder. The first elastic members are respectively welded to the first welding portions.

In the above thin multi-magnetic vibration-damping loudspeaker, a second connecting groove is provided two sides of the magnetic plate. The second connecting groove is provided with a second elastic member. Two sides of the second elastic member are respectively welded to the second welding portions.

In the above thin multi-magnetic vibration-damping loudspeaker, the second elastic member includes two second outer fixing portions, a second inner fixing portion and two second elastic portions. The second elastic portions are arranged between the second outer fixing portions and the second inner fixing portion. A third connecting groove is provided between the second inner fixing portion and the second elastic portions. The third connecting groove is provided at the second connecting groove. The second outer fixing portions extend out of the magnetic plate to be respectively welded to the second welding portions.

In the above thin multi-magnetic vibration-damping loudspeaker, each of the second elastic portions is covered with a buffer portion.

In the above thin multi-magnetic vibration-damping loudspeaker, each of the second outer fixing portions is provided with at least one second through hole, and each of the second outer fixing portions is welded to each of the second welding portions through the second through hole.

In the above thin multi-magnetic vibration-damping loudspeaker, at least one first buffer unit is arranged between the speaker base and the first concave portion, and at least one second buffer unit is arranged between the speaker base and the second concave portion.

Thereby, the thin multi-magnetic vibration-damping loudspeaker of the present disclosure can provide more magnetic energy by using the magnetic assembly to increase a volume during operation and can form a buffer between the speaker base and the magnetic assembly by using first elastic members to reduce resonance of the speaker base and improve stability during operation.

### BRIEF DESCRIPTION OF THE DRAWINGS

FIG. 1 is a schematic outside view I of a first preferred specific example of the present disclosure.

FIG. 2 is a schematic outside view II of the first preferred specific example of the present disclosure.

FIG. 3 is a schematic exploded view I of the first preferred specific example of the present disclosure.

FIG. 4 is a schematic exploded view II of the first preferred specific example of the present disclosure.

FIG. 5 is a schematic exploded view III of the first preferred specific example of the present disclosure.

FIG. 6 is a schematic sectional view I of the first preferred specific example of the present disclosure.

FIG. 7 is a schematic sectional view II of the first preferred specific example of the present disclosure.

FIG. 8 is a schematic exploded view I of a second preferred specific example of the present disclosure.

FIG. 9 is a schematic exploded view II of the second preferred specific example of the present disclosure.

FIG. 10 is a schematic exploded view III of the second preferred specific example of the present disclosure.

FIG. 11 is a schematic bottom view of the second preferred specific example of the present disclosure.

FIG. 12 is a schematic sectional view of the second preferred specific example of the present disclosure.

FIG. 13 is a schematic view showing the arrangement of first buffer units according to a third preferred specific example of the present disclosure.

FIG. 14 is a schematic view showing the arrangement of the first buffer units and second buffer units according to the third preferred specific example of the present disclosure.

### DETAILED DESCRIPTION OF THE INVENTION

In order to fully understand the objectives, features and effects of the present disclosure, a detailed description of the present disclosure will be made below with reference to the following specific examples and accompanying drawings.

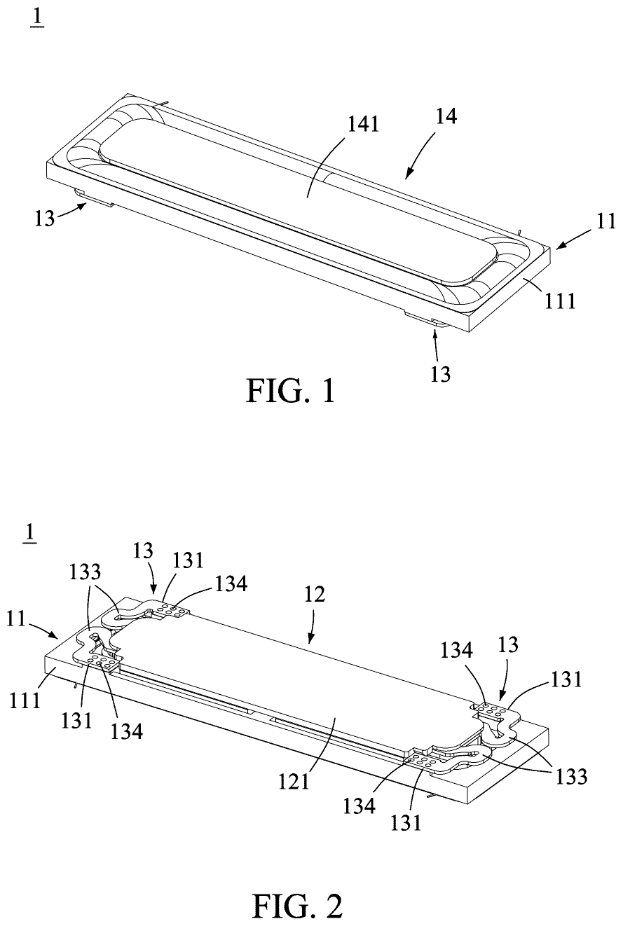

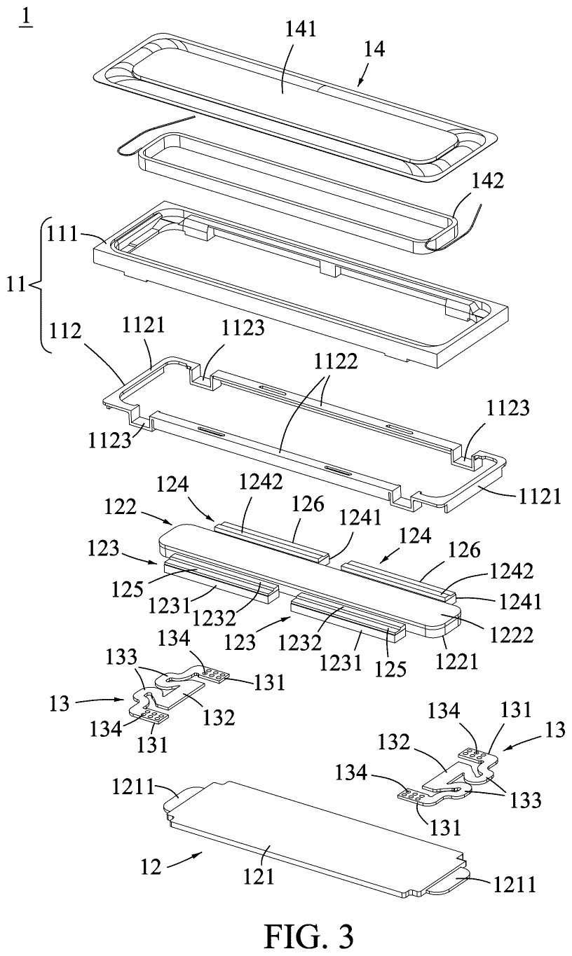

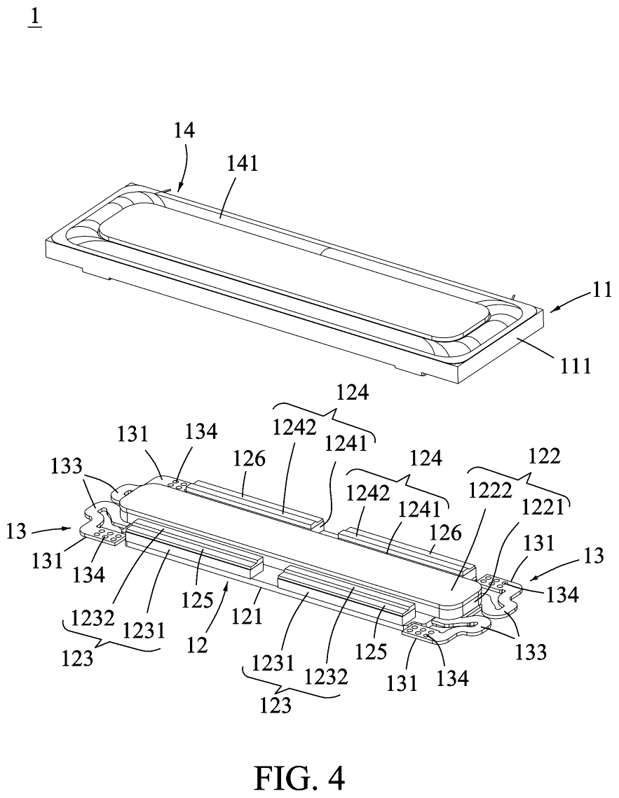

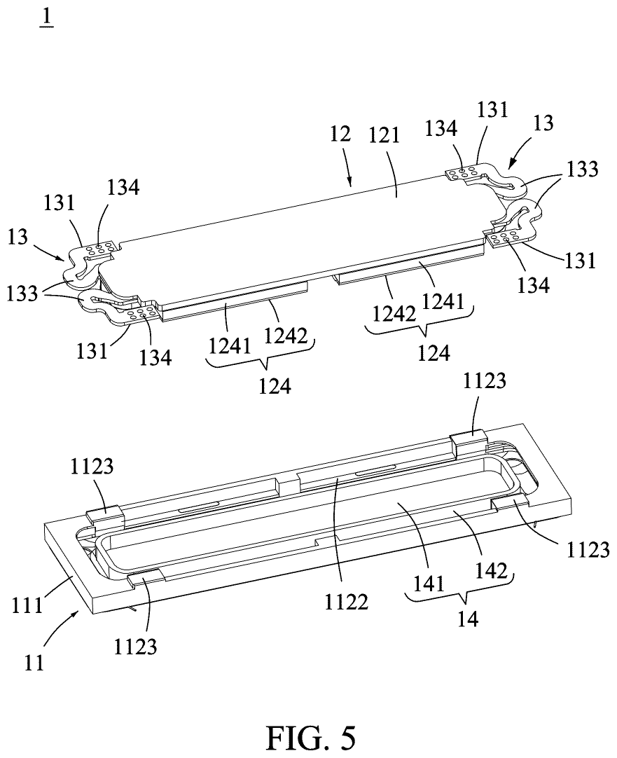

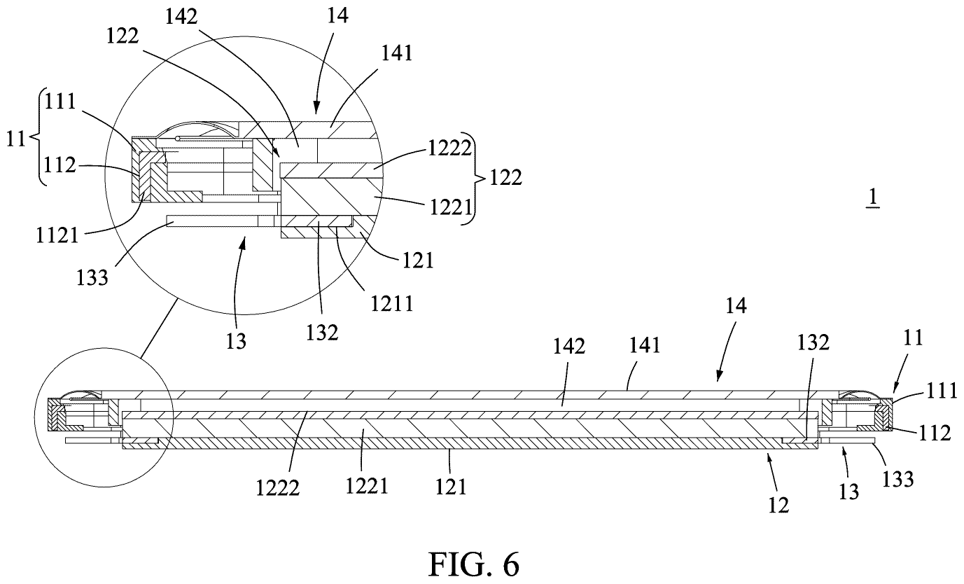

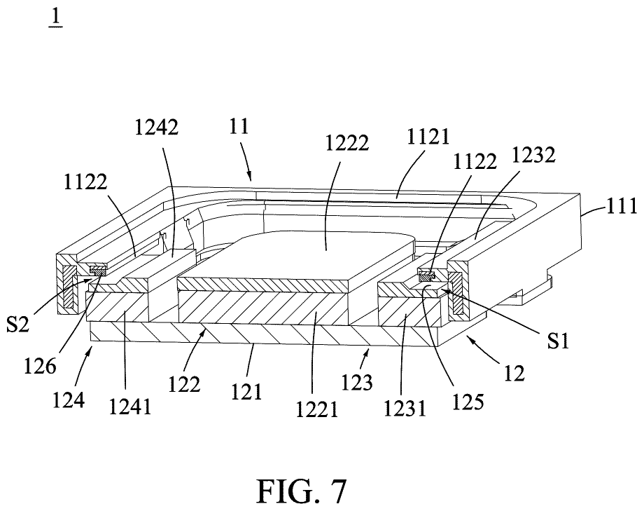

Referring to FIG. 1 to FIG. 7, the present disclosure provides a thin multi-magnetic vibration-damping loudspeaker 1 (for example, a long thin loudspeaker), including: a speaker base 11, a magnetic assembly 12, two first elastic members 13 and a vibration assembly 14.

The speaker base 11 may include a speaker base holder 111 and a metal holder 112. The speaker base holder 111 and the metal holder 112 may be frame-shaped. The speaker base holder 111 may partially cover the metal holder 112. The metal holder 112 may be made of weakly magnetic or nonmagnetic stainless steel or other metals. The stainless steel may be 3XX series (e.g. 301, 302, 304, etc.) or 2XX series (e.g. 201, 204, etc.) austenitic stainless steel. The speaker base holder 111 may be injection-molded to partially cover the outside of the metal holder 112. Thereby, the speaker base 11 may use the combination of the speaker base holder 111 and the metal holder 112 to increase an overall strength of the speaker base 11, thereby alleviating resonance of the thin multi-magnetic vibration-damping loudspeaker 1, especially a rectangular loudspeaker with a high length-to-width ratio.

The magnetic assembly 12 includes a magnetic plate 121, a main magnetic unit 122, at least one first auxiliary magnetic unit 123 and at least one second auxiliary magnetic unit 124. The main magnetic unit 122 is arranged at a top of the magnetic plate 121. The first auxiliary magnetic unit 123 is arranged at the top of the magnetic plate 121 and on one side of the main magnetic unit 122 at an interval, and the second auxiliary magnetic unit 124 is arranged at the top of the magnetic plate 121 and on the other side of the main magnetic unit 122 at an interval, so that a magnetic gap is formed between the main magnetic unit 122, and the first auxiliary magnetic unit 123 and the second auxiliary magnetic unit 124. A first spacing S1 exists between a top of the first auxiliary magnetic unit 123 and the speaker base 11 (or the metal holder 112). A second spacing S2 exists between a top of the second auxiliary magnetic unit 124 and the speaker base 11 (or the metal holder 112). In addition, a side of the top of the first auxiliary magnetic unit 123 away from the magnetic gap may be provided with a first concave portion 125 corresponding to the speaker base 11 (or the metal holder 112). The first spacing S1 may exist between the first concave portion 125 and the speaker base 11 (or the metal holder 112). A side of the top of the second auxiliary magnetic unit 124 away from the magnetic gap may be provided with a second concave portion 126 corresponding to the speaker base 11 (or the metal holder 112). The second spacing S2 may exist between the second concave portion 126 and the speaker base 11 (or the metal holder 112). Thereby, when the speaker base 11 does not have the metal holder 112, the first concave portion 125 and the second concave portion 126 can maintain the first spacing S1 and the second spacing S2 without damaging a magnetic force of the magnetic assembly 12 and increasing a height of the loudspeaker, so as to avoid the collision between the speaker base 11 and the magnetic assembly 12 when the loudspeaker works. In addition, when the speaker base 11 has the metal holder 112, especially the metal holder 112 with weak magnetism, the first concave portion 125 and the second concave portion 126 can prevent the attraction of the first auxiliary magnetic unit 123 and the second auxiliary magnetic unit 124 to the metal holder 112 from being greater than a yield strength of the speaker base 11 when the loudspeaker does not work, which causes the metal holder 112 to bend and deform toward the first auxiliary magnetic unit 123 and the second auxiliary magnetic unit 124, causing the metal holder 112 to be separated from the speaker base 11, making a vibration damping function of the loudspeaker ineffective and generating problems such as abnormal noise and distortion. The main magnetic unit 122 may be provided with a main magnet 1221 and a main magnetic plate 1222 stacked with each other. The main magnet 1221 is closely attached to the top of the magnetic plate 121. The first auxiliary magnetic unit 123 is provided with a first auxiliary magnet 1231 and a first auxiliary magnetic plate 1232 stacked with each other. The first auxiliary magnet 1231 is closely attached to the top of the magnetic plate 121. The first concave portion 125 may be provided on the side of the top of the first auxiliary magnetic plate 1232 away from the magnetic gap. The second auxiliary magnetic unit 124 is provided with a second auxiliary magnet 1241 and a second auxiliary magnetic plate 1242 stacked with each other. The second auxiliary magnet 1241 is closely attached to the top of the magnetic plate 121. The second concave portion 126 may be provided on the side of the top of the second auxiliary magnetic plate 1242 away from the magnetic gap. A number of the first auxiliary magnetic unit 123 and the second auxiliary magnetic unit 124 may be respectively one so as to form the tri-magnetic magnetic assembly 12, and the first auxiliary magnetic unit 123 and the second auxiliary magnetic unit 124 may be respectively arranged in a middle of two long sides of the magnetic plate 121. Alternatively, the number of the first auxiliary magnetic unit 123 and the second auxiliary magnetic unit 124 may be respectively two and the two first auxiliary magnetic units and the two second auxiliary magnetic units are respectively arranged at an interval so as to form the penta-magnetic magnetic assembly 12. The first concave portion 125 may be arranged on the side of the top of each of the first auxiliary magnetic plates 1232 away from the magnetic gap. The second concave portion 126 may be arranged on the side of the top of each of the second auxiliary magnetic plates 1242 away from the magnetic gap. The present disclosure takes the penta-magnetic magnetic assembly 12 as an example. Thereby, the magnetic assembly 12 can provide more magnetic energy through the cooperation of the main magnetic unit 122, each of the first auxiliary magnetic units 123 and each of the second auxiliary magnetic units 124 so as to increase the volume of the thin multi-magnetic vibration-damping loudspeaker 1 during operation.

Each of the first elastic members 13 are connected between the speaker base 11 and the magnetic assembly 12, so that the magnetic assembly 12 avoids direct contact with the speaker base 11. Thereby, the first elastic members 13 may form a buffer between the speaker base 11 and the magnetic assembly 12 so as to reduce the vibration of the speaker base 11 during operation of the thin multi-magnetic vibration-damping loudspeaker 1, thereby improving the stability of the thin multi-magnetic vibration-damping loudspeaker 1 during operation.

The vibration assembly 14 includes a vibrating diaphragm 141 and a voice coil 142. The vibrating diaphragm 141 is closely attached to a top of the speaker base 11 and corresponds to the magnetic assembly 12 in position. The voice coil 142 is movably arranged at the magnetic gap of the magnetic assembly 12 and closely attached to a bottom of the vibrating diaphragm 141. The vibrating diaphragm 141 and the voice coil 142 may be slightly rectangular.

The thin multi-magnetic vibration-damping loudspeaker 1 may be used in combination with a loudspeaker box (not shown). After the voice coil 142 receives an externally inputted electronic signal, the main magnetic unit 122, the first auxiliary magnetic unit 123 and the second auxiliary magnetic unit 124 can cooperate to provide more magnetic energy, so that the voice coil 142 can cooperate with the electromagnetic action of the magnetic assembly 12 to drive the vibrating diaphragm 141 to work, thereby improving the volume of the thin multi-magnetic vibration-damping loudspeaker 1 during operation.

In addition, when the thin multi-magnetic vibration-damping loudspeaker 1 operates as described above, due to the arrangement of the first elastic members 13, the magnetic assembly 12 is suspended in the speaker base 11, so a buffer can be formed between the speaker base 11 and the magnetic assembly 12 by using the first elastic members 13. Furthermore, when the voice coil 142 drives the vibrating diaphragm 141 to vibrate, the speaker base 11 is driven to vibrate. Since the reaction force of the working of voice coil 142 will be applied to the magnetic assembly 12 and the magnetic assembly 12 is suspended by the first elastic members 13, the magnetic assembly 12 will produce kinetic energy similar in frequency but opposite in phase to the speaker base 11 to offset the vibration of the speaker base 11 so as to achieve the purpose of damping vibration, thereby improving the stability of the thin multi-magnetic vibration-damping loudspeaker 1 during operation.

In addition to the above example, in an example of the present disclosure, two short sides of the metal holder 112 may be respectively provided with a short side portion 1121, or two long sides of the metal holder 112 may be respectively provided with a long side portion 1122. Sections of the short side portions 1121 may be respectively L-shaped, and sections of the long side portions 1122 may be respectively L-shaped. In addition, the metal holder 112 may also be provided with both two short side portions 1121 and two long side portions 1122. Furthermore, two ends of each of the long side portions 1122 may be respectively provided with a first welding portion 1123 to be adjacent to the short side portions 1121. Each of the first welding portions 1123 may be U-shaped. The speaker base holder 111 may be injection-molded to partially cover the short side portions 1121 and the long side portions 1122 of the metal holder 112. Each of the first welding portions 1123 may be exposed from a bottom of the speaker base holder 111. The first elastic members 13 may be respectively welded to the first welding portions 1123. Thereby, the metal holder 112 can form an angle steel-like structure by using the short side portions 1121 and the long side portions 1122 to strengthen the support of the metal holder 112 to the speaker base holder 111. Moreover, with the arrangement of the first welding portions 1123, each of the first elastic members 13 can be welded to each of the first welding portions 1123 by way of welding (laser spot welding), so that the first elastic members 13 can be combined with the metal holder 112 more firmly. Moreover, the magnetic assembly 12 avoids direct contact the speaker base 11, so that the first elastic members 13 can form a buffer between the speaker base 11 and the magnetic assembly 12, thereby reducing the vibration of the speaker base 11 during operation of the thin multi-magnetic vibration-damping loudspeaker 1 and improving the stability of the thin multi-magnetic vibration-damping loudspeaker 1 during operation.

In addition to the above example, in an example of the present disclosure, two short sides of the magnetic plate 121 may be respectively provided with a first connecting groove 1211. Two short sides of a bottom of the main magnet 1221 of the main magnetic unit 122 may respectively correspond to the first connecting grooves 1211. One side of each of the first elastic members 13 may be respectively arranged at each of the first connecting grooves 1211. In addition, the two short sides of the bottom of the main magnet 1221 of the main magnetic unit 122 may respectively abut against the sides of the first elastic member 13, so that the first elastic members 13 can be respectively sandwiched between the first connecting groove 1211 and the two short sides of the bottom of the main magnet 1221. Thereby, the first elastic members 13 can be prevented from being separated from the magnetic assembly 12 during working. In addition, since the two short sides of the main magnet 1221 respectively extend to cover the first elastic members 13, the main magnet 1221 is designed with a longer size, so that the magnetic force of the main magnet 1221 can be increased and a larger output volume can be provided.

In addition to the above example, in an example of the present disclosure, the first spacing S1 and the second spacing S2 may be respectively greater than 0.2 mm. Thereby, the side of the top of the first auxiliary magnetic plate 1232 of the first auxiliary magnetic unit 123 away from the magnetic gap can be die-cut and thinned to form the first concave portion 125, and the side of the top of the second auxiliary magnetic plate 1242 of the second auxiliary magnetic unit 124 away from the magnetic gap can be die-cut and thinned to form the second concave portion 126, so that the first concave portion 125 and the second concave portion 126 can be descending surfaces corresponding to the lower part of the metal holder 112 so as to ensure that the first spacing S1 and the second spacing S2 to be respectively greater than 0.2 mm. Thereby, the first spacing S1 and the second spacing S2 can be used to prevent the metal holder 112 from being continuously attracted by the magnetic force of the magnetic assembly 12, causing the speaker base 11 to be deformed. In addition, according to the thin multi-magnetic vibration-damping loudspeaker 1 of the present disclosure, outer sides of the first auxiliary magnetic plate 1232 and the second auxiliary magnetic plate 1242 can be made thinner by using the first concave portion 125 and the second concave portion 126 without increasing the height of the loudspeaker so as to form the first spacing S1 and the second spacing S2, instead of making the whole first auxiliary magnetic plate 1232 and the whole second auxiliary magnetic plate 1242 thinner, resulting in poor magnetic conductivity. Therefore, the thin multi-magnetic vibration-damping loudspeaker 1 of the present disclosure can avoid reducing the magnetic force and increasing the height of the loudspeaker.

In addition to the above example, in an example of the present disclosure, each of the first elastic members 13 may include two first outer fixing portions 131, a first inner fixing portion 132 and two first elastic portions 133. The first elastic portions 133 may be arranged between the first outer fixing portions 131 and the first inner fixing portion 132. The first outer fixing portions 131 may be respectively connected to bottoms of the first welding portions 1123 of the metal holder 112. The first inner fixing portions 132 may be respectively arranged at the first connecting grooves 1211 on the two short sides of the magnetic plate 121. In addition, the first inner fixing portions 132 may be respectively sandwiched between the first connecting grooves 1211 on the two short sides of the magnetic plate 121 and the two short sides of the bottom of the main magnet 1221 of the main magnetic unit 122. Thereby, each of the first elastic members 13 can be combined with the metal holder 112 more firmly, and the magnetic assembly 12 avoids direct contact with the speaker base 11, so that the first elastic members 13 can form a buffer between the speaker base 11 and the magnetic assembly 12, thereby reducing the vibration of the speaker base 11 during operation of the thin multi-magnetic vibration-damping loudspeaker 1 and improving the stability of the thin multi-magnetic vibration-damping loudspeaker 1 during operation.

In addition to the above example, in an example of the present disclosure, each of the first outer fixing portions 131 may be provided with at least one first through hole 134, and each of the first outer fixing portions 131 may be welded to the bottom of each of the first welding portions 1123 of the metal holder 112 through the first through hole 134. Thereby, each of the first outer fixing portions 131 of each of the first elastic members 13 can be welded to each of the first welding portions 1123 by way of welding (laser spot welding) through the first through holes 134 of each of the first outer fixing portions 131, so that each of the first elastic members 13 can be combined with the metal holder 112 more firmly and the magnetic assembly 12 avoids direct contact with the speaker base 11. Further, the first elastic members 13 can form a buffer between the speaker base 11 and the magnetic assembly 12, thereby reducing the vibration of the speaker base 11 during operation of the thin multi-magnetic vibration-damping loudspeaker 1 and improving the stability of the thin multi-magnetic vibration-damping loudspeaker 1 during operation.

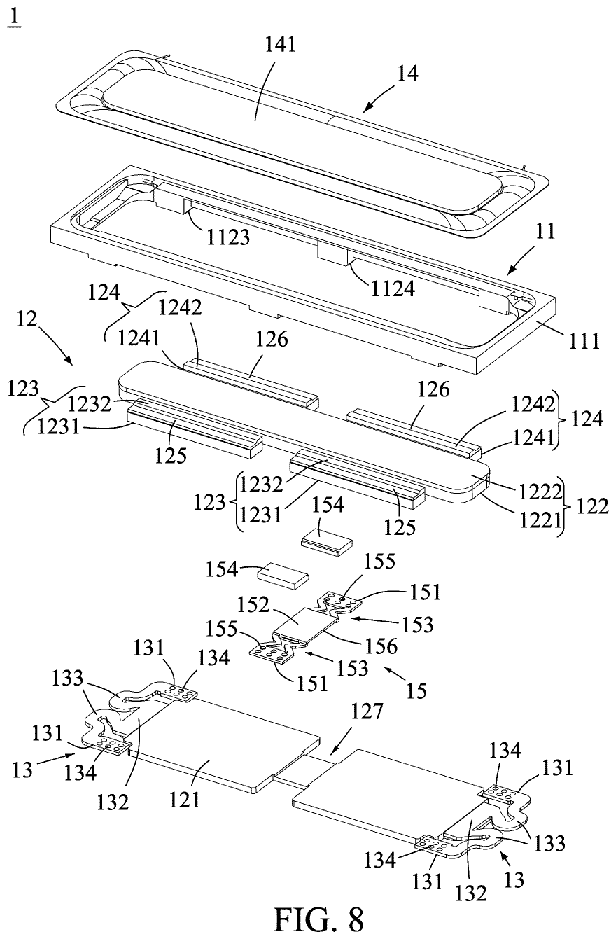

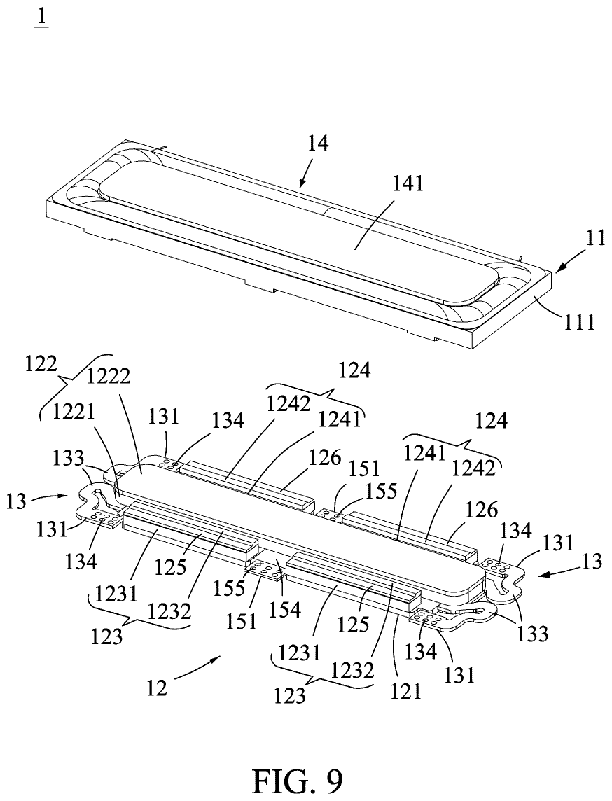

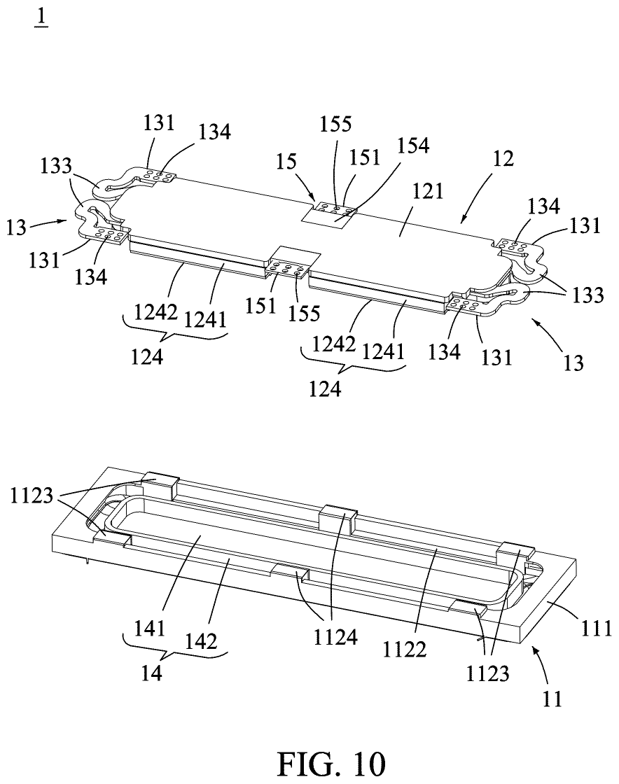

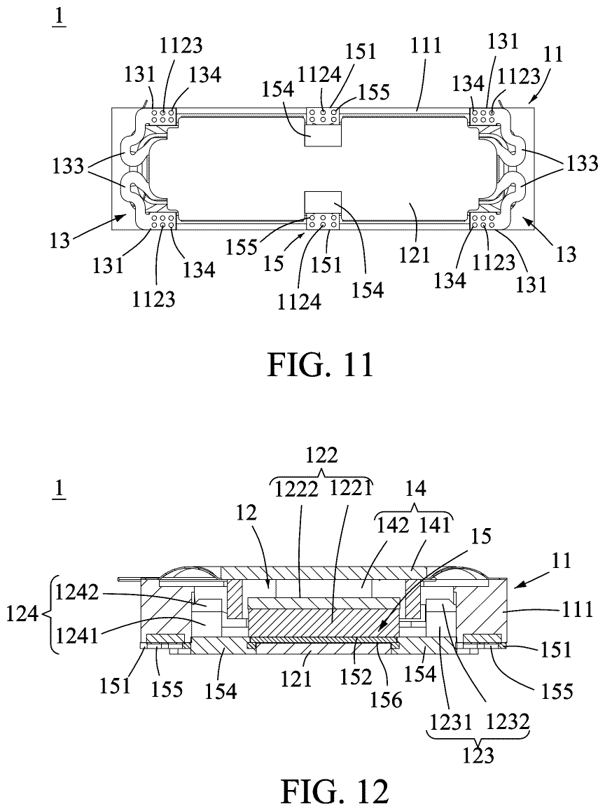

Referring to FIG. 8 to FIG. 12, in addition to the above example, in an example of the present disclosure, a second welding portion 1124 may be arranged respectively between two ends of each of the long side portions 1122. Each of the second welding portions 1124 may be U-shaped. The speaker base holder 111 may be injection-molded to partially cover the short side portions 1121 and the long side portions 1122 of the metal holder 112. The first welding portions 1123 and the second welding portions 1124 may be exposed from the bottom of the speaker base holder 111. In addition, a second connecting groove 127 may be arranged between two short sides of the magnetic plate 121. Moreover, the second connecting groove 127 may be provided with a second elastic member 15. The second elastic member 15 may be a stainless steel elastic piece. Two sides of each of the first elastic members 13 may be respectively welded to the first welding portions 1123, and two sides of the second elastic member 15 may be respectively welded to the second welding portions 1124. Thereby, according to the thin multi-magnetic vibration-damping loudspeaker 1 of the present disclosure, the first elastic members 13 can be used to form a buffer between the speaker base 11 and the magnetic assembly 12, and the second elastic member 15 can be also used to strengthen the support to the magnetic assembly 12, thereby suppressing the unstable vibration of the magnetic assembly 12 and absorbing redundant vibration kinetic energy of the magnetic assembly 12. In addition, when the voice coil 142 drives the vibrating diaphragm 141 to vibrate, the speaker base 11 is driven to vibrate. Since the reaction force of the working of voice coil 142 will be applied to the magnetic assembly 12 and the magnetic assembly 12 is suspended by the first elastic members 13 and the second elastic member 15, the magnetic assembly 12 will produce kinetic energy similar in frequency but opposite in phase to the speaker base 11 to offset the vibration of the speaker base 11 so as to achieve the purpose of damping vibration, thereby improving the stability of the thin multi-magnetic vibration-damping loudspeaker 1 during operation.

In addition to the above example, in an example of the present disclosure, the second elastic member 15 may include two second outer fixing portions 151, a second inner fixing portion 152 and two second elastic portions 153. The second elastic portions 153 are arranged between the second outer fixing portions 151 and the second inner fixing portion 152. A third connecting groove 156 may be provided between the second inner fixing portion 152 and the second elastic portions 153. The third connecting groove 156 may be provided at the second connecting groove 127. The second outer fixing portions 151 may respectively extend out of the magnetic plate 121 to be welded to the second welding portions 1124. Each of the second elastic portions 153 may be covered with a buffer portion 154 by silicone injection molding. Thereby, according to the thin multi-magnetic vibration-damping loudspeaker 1 of the present disclosure, each of the second elastic portions 153 can be used to absorb the redundant vibration kinetic energy of the magnetic assembly 12 to increase the vibration stability of the magnetic assembly 12. Moreover, after the second elastic member 15 is arranged in the second connecting groove 127 through the third connecting groove 156, the second inner fixing portion 152 can abut against the magnetic plate 121 without exceeding the top of the magnetic plate 121, so that the magnetic plate can be closely attached to the main magnet 1221. In addition, after each of the buffer portions 154 covers each of the second elastic portions 153, a top of each of the buffer portions 154 can be flush with the top of the magnetic plate 121 in height, and a bottom of each of the buffer portions 154 does not exceed the bottom of the magnetic plate 121, so that a gap between each of the buffer portions 154 and the magnetic plate 121 is extremely small, which reduces the sound transmission area of the loudspeaker, thereby avoiding affecting the sound quality performance of the loudspeaker.

In addition to the above example, in an example of the present disclosure, each of the second outer fixing portions 151 may be provided with at least one second through hole 155, and each of the second outer fixing portions 151 may be welded to each of the second welding portions 1124 through the second through hole 155. Thereby, each of the second outer fixing portions 151 of the second elastic members 15 can be welded to each of the second welding portions 1124 by way of welding (laser spot welding) through the second through holes 155 of each of the second outer fixing portions 151, so that the second elastic members 15 can cooperate with the first elastic members 13 to be combined with the metal holder 112 more firmly and the magnetic assembly 12 avoids direct contact with the speaker base 11. Further, the first elastic members 13 and the second elastic members 15 can form a buffer between the speaker base 11 and the magnetic assembly 12, thereby reducing the vibration of the speaker base 11 during operation of the thin multi-magnetic vibration-damping loudspeaker 1 and improving the stability of the thin multi-magnetic vibration-damping loudspeaker 1 during operation.

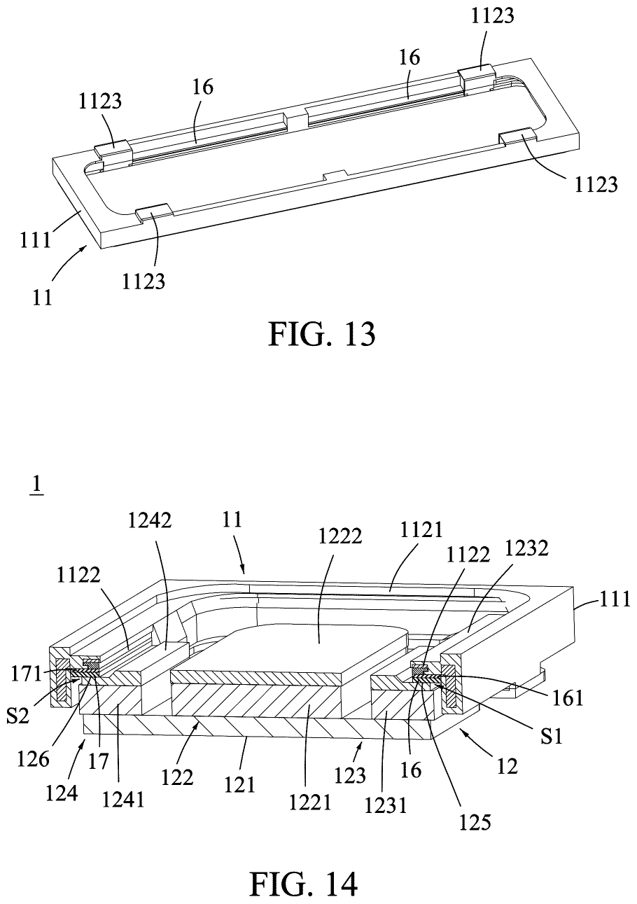

Referring to FIG. 13 and FIG. 14, in addition to the above example, in an example of the present disclosure, at least one first buffer unit 16 may be arranged in the first spacing S1 between the speaker base holder 111 or the metal holder 112 of the speaker base 11 and the first concave portion 125, and at least one second buffer unit 17 may be arranged in the second spacing S2 between the speaker base holder 111 or the metal holder 112 of the speaker base 11 and the second concave portion 126. The first buffer unit 16 may be sponge, cured soft glue or other soft materials. The first buffer unit 16 may be attached to the speaker base holder 111 or the metal holder 112 of the speaker base 11 by at least one first adhesive backing 161. The second buffer unit 17 may be sponge, cured soft glue or other soft materials. The second buffer unit 17 may be attached to the speaker base holder 111 or the metal holder 112 of the speaker base 11 by at least one second adhesive backing 171. Thereby, the first buffer unit 16 and the second buffer unit 17 can avoid abnormal noise and distortion caused by direct contact between the speaker base 11 and the magnetic assembly 12 due to excessive displacement during working.

The present disclosure has been disclosed above with preferred examples, but it should be understood by those skilled in the art that the examples are only used for describing the present disclosure and should not be interpreted as limiting the scope of the present disclosure. It should be noted that all changes and substitutions equivalent to the examples shall fall within the scope of the present disclosure. Therefore, the scope of protection of the present disclosure shall be as defined in the claims.

What is claimed is:

1. A thin multi-magnetic vibration-damping loudspeaker, comprising:
a speaker base;
a magnetic assembly, comprising a magnetic plate, a main magnetic unit, at least one first auxiliary magnetic unit and at least one second auxiliary magnetic unit, the main magnetic unit being arranged at the magnetic plate, the first auxiliary magnetic unit being arranged at the magnetic plate and on one side of the main magnetic unit at an interval, the second auxiliary magnetic unit being arranged at the magnetic plate and on the other side of the main magnetic unit at an interval, a first spacing existing between a top of the first auxiliary magnetic unit and the speaker base, and a second spacing existing between a top of the second auxiliary magnetic unit and the speaker base;
two first elastic members, each of the first elastic members being connected between the speaker base and the magnetic assembly; and
a vibration assembly, comprising a vibrating diaphragm and a voice coil, the vibrating diaphragm being arranged at the speaker base, and the voice coil being movably arranged at the magnetic assembly and connected to the vibrating diaphragm.

2. The thin multi-magnetic vibration-damping loudspeaker according to claim 1, wherein a side of the top of the first auxiliary magnetic unit is provided with a first concave portion corresponding to the speaker base, the first spacing existing between the first concave portion and the speaker base, and a side of the top of the second auxiliary magnetic unit is provided with a second concave portion corresponding to the speaker base, the second spacing existing between the second concave portion and the speaker base.

3. The thin multi-magnetic vibration-damping loudspeaker according to claim 2, wherein the speaker base comprises a speaker base holder and a metal holder, the speaker base holder partially covers the metal holder, the side of the top of the first auxiliary magnetic unit is provided with the first concave portion corresponding to the metal holder, the first spacing existing between the first concave portion and the metal holder, and the side of the top of the second auxiliary magnetic unit is provided with the second concave portion corresponding to the metal holder, the second spacing existing between the second concave portion and the metal holder.

4. The thin multi-magnetic vibration-damping loudspeaker according to claim 3, wherein the metal holder is made of austenitic stainless steel.

5. The thin multi-magnetic vibration-damping loudspeaker according to claim 3, wherein the metal holder has two short side portions or two long side portions, sections of the short side portions are respectively L-shaped, and sections of the long side portions are respectively L-shaped.

6. The thin multi-magnetic vibration-damping loudspeaker according to claim 3, wherein the metal holder has two short side portions and two long side portions, two ends of each of the long side portions are respectively provided with a first welding portion to be adjacent to the short side portions, the speaker base holder is injection-molded to partially cover the metal holder, each of the first welding portions is exposed from the speaker base holder, and the first elastic members are respectively welded to the first welding portions.

7. The thin multi-magnetic vibration-damping loudspeaker according to claim 1, wherein two sides of the magnetic plate are respectively provided with a first connecting groove, and one side of each of the first elastic members is arranged at each of the first connecting grooves.

8. The thin multi-magnetic vibration-damping loudspeaker according to claim 7, wherein two sides of the main magnetic unit respectively correspond to the first connecting grooves, and one side of each of the first elastic members is sandwiched between each of the first connecting grooves and the main magnetic unit.

9. The thin multi-magnetic vibration-damping loudspeaker according to claim 2, wherein the main magnetic unit is provided with a main magnet and a main magnetic plate stacked with each other, the main magnet is closely attached to the magnetic plate, a number of the first auxiliary magnetic unit is one, the first auxiliary magnetic unit is provided with a first auxiliary magnet and a first auxiliary magnetic plate stacked with each other, the first auxiliary magnet is closely attached to the magnetic plate, the first concave portion is provided on a side of a top of the first auxiliary magnetic plate, a number of the second auxiliary magnetic unit is one, the second auxiliary magnetic unit is provided with a second auxiliary magnet and a second auxiliary magnetic plate stacked with each other, the second auxiliary magnet is closely attached to the magnetic plate, and the second concave portion is provided on a side of a top of the second auxiliary magnetic plate, so as to form a tri-magnetic magnetic assembly.

10. The thin multi-magnetic vibration-damping loudspeaker according to claim 2, wherein the main magnetic unit is provided with a main magnet and a main magnetic plate stacked with each other, the main magnet is closely attached to the magnetic plate, a number of the first auxiliary magnetic unit is two and the two first auxiliary magnetic units are arranged at an interval, each of the first auxiliary magnetic units is provided with a first auxiliary magnet and a first auxiliary magnetic plate stacked with each other, each of the first auxiliary magnets is closely attached to the magnetic plate, the first concave portion is arranged on a side of a top of each of the first auxiliary magnetic plates, a number of the second auxiliary magnetic unit is two and the two second auxiliary magnetic units are arranged at an interval, each of the second auxiliary magnetic units is provided with a second auxiliary magnet and a second auxiliary magnetic plate stacked with each other, each of the second auxiliary magnets is closely attached to the magnetic plate, and the second concave portion is arranged on a side of a top of each of the second auxiliary magnetic plates, so as to form a penta-magnetic magnetic assembly.

11. The thin multi-magnetic vibration-damping loudspeaker according to claim 1, wherein the first spacing is greater than 0.2 mm, and the second spacing is greater than 0.2 mm.

12. The thin multi-magnetic vibration-damping loudspeaker according to claim 3, wherein each of the first elastic members comprises two first outer fixing portions, a first inner fixing portion and two first elastic portions, the first elastic portions are arranged between the first outer fixing portions and the first inner fixing portion, the first outer fixing portions are connected to the metal holder, and the first inner fixing portion is arranged at the magnetic plate.

13. The thin multi-magnetic vibration-damping loudspeaker according to claim 12, wherein the first inner fixing portion is sandwiched between the magnetic plate and the main magnetic unit.

14. The thin multi-magnetic vibration-damping loudspeaker according to claim 12, wherein each of the first outer fixing portions is provided with at least one first through hole, and each of the first outer fixing portions is welded to the metal holder through the first through hole.

15. The thin multi-magnetic vibration-damping loudspeaker according to claim 3, wherein the metal holder has two short side portions and two long side portions, two ends of each of the long side portions are respectively provided with a first welding portion to be adjacent to the short side portions, a second welding portion is arranged respectively two ends of each of the long side portions, the speaker base holder is injection-molded to partially cover the metal holder, each of the first welding portions and each of the second welding portions are exposed from the speaker base holder, and the first elastic members are respectively welded to the first welding portions.

16. The thin multi-magnetic vibration-damping loudspeaker according to claim 15, wherein a second connecting groove is provided two sides of the magnetic plate, the second connecting groove is provided with a second elastic member, and two sides of the second elastic member are respectively welded to the second welding portions.

17. The thin multi-magnetic vibration-damping loudspeaker according to claim 16, wherein the second elastic member comprises two second outer fixing portions, a second inner fixing portion and two second elastic portions, the second elastic portions are arranged between the second outer fixing portions and the second inner fixing portion, a third connecting groove is provided between the second inner fixing portion and the second elastic portions, the third connecting groove is provided at the second connecting groove, and the second outer fixing portions extend out of the magnetic plate to be respectively welded to the second welding portions.

18. The thin multi-magnetic vibration-damping loudspeaker according to claim 17, wherein each of the second elastic portions is covered with a buffer portion.

19. The thin multi-magnetic vibration-damping loudspeaker according to claim 17, wherein each of the second outer fixing portions is provided with at least one second through hole, and each of the second outer fixing portions is welded to each of the second welding portions through the second through hole.

20. The thin multi-magnetic vibration-damping loudspeaker according to claim 2, wherein at least one first buffer unit is arranged between the speaker base and the first concave portion, and at least one second buffer unit is arranged between the speaker base and the second concave portion.
